(19) United States
(12) Patent Application Publication
(10) Pub. No.: US 2023/0360836 A1
(43) Pub. Date: Nov. 9, 2023

(54) TRANSFORMER

(71) Applicant: Siemens Energy Global GmbH & Co. KG, München (DE)

(72) Inventors: Ralf Fischer, Ludwigshafen (DE); Aime Mbuy, Nürnberg-Weiherhaus (DE)

(21) Appl. No.: 18/044,412

(22) PCT Filed: Aug. 25, 2021
(86) PCT No.: PCT/EP2021/073487

§ 371 Date: Mar. 8, 2023

(30) Foreign Application Priority Data
Sep. 8, 2020 (DE) 10 2020 211 253.3

(51) Int. Cl. H01F 27/245; H01F 3/14

(52) U.S. Cl. CPC H01F 27/245; H01F 3/14

(57) ABSTRACT

A transformer has a magnetic core, a coil which runs around a core section of the magnetic core, and a filling layer which is arranged between the core section and the coil. The filling layer, which may fill a gap formed between the core and the coil completely, is produced from a magnetizable material.

The invention relates to a transformer.

A transformer generally has a magnetic core around which at least one coil on the primary side and at least one coil on the secondary side run. The magnetic core is usually made of electrical sheet metal to counteract eddy currents in the magnetic core. For this purpose, layers of electrical sheet metal are laminated and joined together to form the magnetic core, electrically insulated from one another. As a result, the magnetic core has a surface with edges and/or steps formed by the electrical steel layers. This creates air-filled gaps between the coils and the surface of the magnetic core, which remain unused for conducting a magnetic flux.

The invention is based on the object of specifying a transformer which is improved with regard to the conduction of a magnetic flux.

The object is achieved by a transformer with the features of claim 1.

Advantageous configurations of the invention are the subject matter of the dependent claims.

A transformer according to the invention comprises a magnetic core, a coil running around a core section of the magnetic core and a filling layer which is arranged between the core section and the coil and is made of a magnetizable material.

The magnetizable filling layer fills an otherwise air-filled space between the magnetic core and the coil of the transformer with magnetizable material. The filling layer supports the conduction of a magnetic flux of the magnetic core of the transformer by increasing the cross-sectional area enclosed by the coil, which is filled with magnetizable material. Compared to a conventional transformer without a magnetizable filling layer, less electrical steel is required to achieve the same magnetic flux, especially with the same coil diameter. As a result, material and costs for manufacturing the magnetic core can be saved without increasing the electromagnetic induction in the magnetic core. In addition, support structures in the transformer, such as pressboard or paper cylinders, can be reduced since their function can be partially taken over by the filling layer. This also allows costs for the manufacture of the transformer to be reduced.

In one embodiment of the invention, the filling layer completely fills an intermediate space between the core section and the coil.

The aforementioned embodiment of the invention advantageously uses the entire space between the magnetic core and the coil to conduct the magnetic flux. This optimizes the effect of the filling layer.

In a further embodiment of the invention, the filling layer is made from a paramagnetic material.

Through the use of a paramagnetic material, the magnetization of the filling layer follows the magnetic field generated by the coil and thus advantageously increases the magnetic flux conducted by the magnetic core.

In a further embodiment of the invention, the filling layer has a higher permeability number than air.

The aforementioned embodiment of the invention takes into account that the conduction of the magnetic flux is only improved relative to a transformer with an air-filled space between the magnetic core and the coil when the filling layer has a higher permeability number than air. The higher this permeability number, the more the filling layer contributes to the conduction of the magnetic flux and relieves the magnetic core, or the more electrical steel can be saved for the production of the magnetic core.

In a further embodiment of the invention, the filling layer is made from a soft-magnetic material. The filling layer is particularly preferably made of a soft-magnetic composite material. Soft magnetic composite material is also referred to as Soft Magnetic Composite (SMC). A soft-magnetic composite material is preferably used which has high mechanical strength and high magnetic permeability. For example, the filling layer is produced by pressing and sintering a soft magnetic powder composite material.

Soft magnetic materials can easily be magnetized in a magnetic field and are therefore particularly suitable as material for the filling layer. Soft magnetic composite materials have the particular advantage that they have significantly higher permeability numbers than air and can be pressed and sintered as a powder. The filling layer can therefore easily be produced as a molded part by pressing and sintering a soft-magnetic powder composite material, with filling layers with complex three-dimensional geometries also being able to be produced.

In a further embodiment of the invention, the filling layer has an outer surface facing away from the core section, which has the shape of a cylinder with a smooth, preferably oval and in particular circular trajectory (curve surface).

This advantageously gives the filling layer a smooth outer surface, around which the coil can be arranged without gaps, in contrast to the surface of a magnetic core made from electrical sheet metal.

In a further embodiment of the invention, the magnetic core is made of electrical steel.

As already explained above, the magnetic core of a transformer is usually made of electrical steel to counteract eddy currents in the magnetic core, and consequently has edges and/or steps. The invention makes it possible to fill the spaces between the magnetic core and the coil that occur in such a magnetic core with the filling layer.

The properties, features and advantages of this invention described above and the manner in which they are achieved will become clearer and more clearly understood in connection with the following description of exemplary embodiments, which will be explained in more detail in connection with the drawings. There is shown:

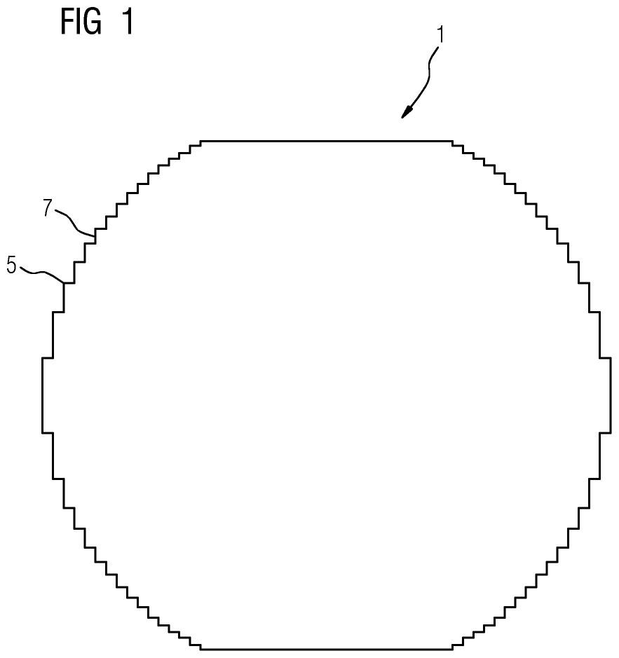

FIG. 1 a cross-sectional representation of a magnetic core of an exemplary embodiment of a transformer,

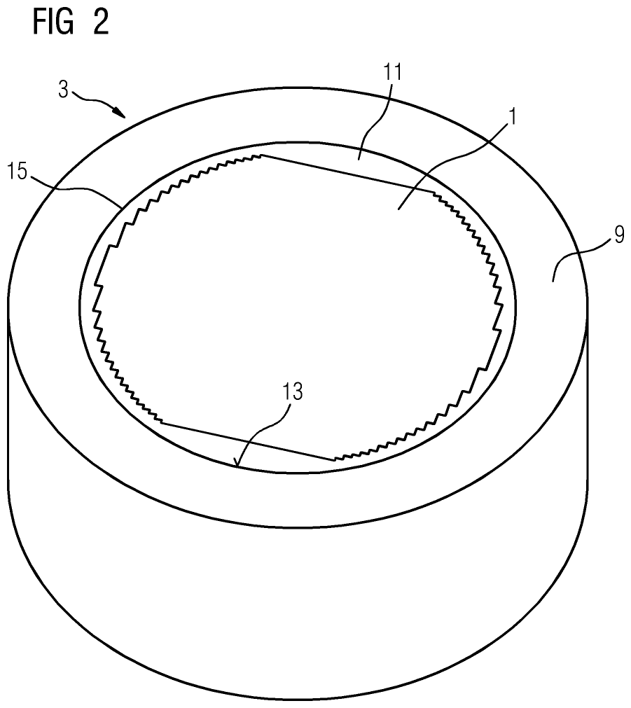

FIG. 2 a perspective sectional view of an exemplary embodiment of a transformer.

Corresponding parts are provided with the same reference symbols in the figures.

FIG. 1 (FIG. 1) shows a cross-sectional illustration of a magnetic core 1 of an exemplary embodiment of a transformer 3 according to the invention (see FIG. 2). The magnetic core 1 is made from electrical steel by laminating electrical steel sheet layers (not shown in detail) and joining them together in an electrically insulated manner. The electrical steel sheet layers are designed and arranged with different widths in such a way that the cross section of the magnetic core 1 approximates a circular area. Due to the layering of the electrical steel sheet the surface of the magnetic core 1 has edges 5 and steps 7.

FIG. 2 (FIG. 2) shows a perspective sectional illustration of an exemplary embodiment of a transformer 3 according to the invention.

The transformer 3 comprises a magnetic core 1, a coil 9 running around a core section of the magnetic core 1, and a magnetizable filling layer 11 arranged between the core section and the coil 9. The magnetic core 1 is designed like the magnetic core 1 described with reference to FIG. 1.

The filling layer 11 fills a space between the core section and the coil 9 completely. The filling layer 11 is made of a paramagnetic material, for example a soft magnetic material, which has a higher permeability number than air. It is especially preferable for the filling layer 11 to be made of a soft-magnetic composite material (SMC), in particular by pressing and sintering a soft-magnetic powder composite material. The filling layer 11 has an outer surface 13 which faces away from the core section and is in the shape of a cylinder with an oval, in particular circular guide curve 15.

The filling layer 11 supports the conduction of a magnetic flux of the magnetic core 1 of the transformer 3 by completely filling the cross-sectional area enclosed by the coil 9 with magnetizable material. Compared to a conventional transformer without the filling layer 11, less electrical steel is required for the same coil diameter in order to achieve the same magnetic flux. An exemplary calculation for a magnetic core 1 with a diameter of 29 cm and a cross-sectional area of 587.5 cm² and the permeability number 2000 and a cross-sectional area of 660.5 cm² enclosed by the coil 9 shows that the cross-sectional area of the magnetic core 1 can be reduced by about 1.3% in order to achieve the same magnetic flux with a filling layer 11 as without the filling layer 11, given the filling layer has the permeability number 200. Furthermore, a simulation based on a finite element method shows that in this example, as a result of the increased effective cross section for conducting the magnetic flux due to the filling layer 11, and by excitation with an electrical coil current of 12 kA, the magnetic flux density in the magnetic core 1 decreases from 193.7 mT to 189 mT, i.e., is reduced by 2% compared to an embodiment without the filling layer 11, and the magnetic core 1 is correspondingly relieved. A filling layer 11 with an even higher permeability number enables a further reduction in the cross-sectional area of the magnetic core 1 and thus a corresponding reduction in the amount of electrical lamination required to produce the magnetic core 1, or an even greater relief of the magnetic core 1.

Although the invention has been illustrated and described in more detail by preferred exemplary embodiments, the invention is not restricted by the examples disclosed and other variations can be derived therefrom by a person skilled in the art without departing from the scope of protection of the invention.

1-10. (canceled)

11. A transformer, comprising:
a magnetic core;
a coil extending around a core section of said magnetic core; and
a filling layer formed of a magnetizable material arranged between said core section and said coil.

12. The transformer according to claim 11, wherein said core section and said coil are disposed to form a gap therebetween, and said filling layer completely fills said gap between said core section and said coil.

13. The transformer according to claim 11, wherein said filling layer is made of a paramagnetic material.

14. The transformer according to claim 11, wherein said filling layer has a higher relative permeability than air.

15. The transformer according to claim 11, wherein said filling layer is made of a soft magnetic material.

16. The transformer according to claim 11, wherein said filling layer is made of a soft magnetic composite material.

17. The transformer according to claim 11, wherein said filling layer is produced by pressing and sintering a soft magnetic powder composite material.

18. The transformer according to claim 11, wherein said filling layer has an outer surface distal from said core section, and said outer surface has a shape of a cylinder with a smooth trajectory.

19. The transformer according to claim 18, wherein said trajectory is oval.

20. The transformer according to claim 19, wherein said trajectory is circular.

21. The transformer according to claim 11, wherein said magnetic core is formed of a plurality of electrical sheets.
